(19) United States
(12) Patent Application Publication
(10) Pub. No.: US 2013/0016634 A1
(43) Pub. Date: Jan. 17, 2013

(54) ELECTRONIC DUPLEXER

(71) Applicant: Russell SMILEY, Richmond (CA)

(72) Inventor: Russell SMILEY, Richmond (CA)

(73) Assignee: TELEFONAKTIEBOLAGET L M ERICSSON (PUBL), Stockholm (SE)

(21) Appl. No.: 13/180,716

(22) Filed: Jul. 12, 2011

(51) Int. Cl. H04W 92/00

(52) U.S. Cl. 370/278

(57) ABSTRACT

The present disclosure relates to an electronic duplexer for at least one transmit path and at least one receive path in a radio system where the transmit and receive paths share the use of at least one antenna. A first feedforward correction loop is used to correct broadband noise emissions (that do not include linearity related close-in emissions) from the power amplifier in a radio system. A second feedforward correction loop is used to reduce the interference of the transmit signal in the receive path. A third feedforward correction loop is used to identify interference signals other than the transmit signal and correct those additional interferers.

### FIELD OF THE INVENTION

The present application relates generally to frequency agile duplexers used in radio systems and, more specifically, to frequency agile electronic duplexers which make use of feedforward cancellation techniques.

### BACKGROUND OF THE INVENTION

The design of wireless base station front ends offers unique challenges. For example, a number of limitations and practical challenges need to be overcome in the areas of high-power filtering, frequency agility, linearity and low insertion loss.

Certain techniques have been devised to attempt to reject the high power transmit signal reflection from the antenna port. A classic arrangement is to establish a Feed Forward Cancellation Loop path between the transmit port and the receive port of the antenna coupling network. One of the only practical method to match such a delay is to use a spool of coax cable in the feedforward path of the FFCL to match the round-trip delay of the transmit signal antenna reflection in the antenna feeder cable. However, given the broad and unpredictable range of feeder cable lengths for each base station deployment, it would be impractical to attempt to control the delay mismatch variation of a feedforward cancellation arrangement with a feedforward path between the transmit and receive ports of the antenna coupling network. Furthermore, even if the feedforward path coax delay line was implemented with smaller gauge cable, the volume occupied by the delay line could easily exceed that of a typical duplexer for large towers (long feeder lengths) and occupy a significant portion of the base station footprint. Additional factors that limit the performance of feedforward cancellation circuits over wide frequency bands is the delay mismatch between the main path and the cancellation path and the inherent frequency dependence of circuit components in terms of amplitude and phase ripple over a given frequency range.

Conventional filter duplexers can be used to isolate the transmit and receive circuitry but unusually strong, close-in interferers may be very difficult to deal with. Additionally, conventional filters are not easily adaptable to new operating frequencies. Existing adaptive/agile/electronic duplexer designs only address one of the noise or emissions problems. Usually this is the broadband transmit noise emissions in the receive path, or even more specifically, just the transmit noise emissions in the receive band of the receive path. Existing feedforward linearization deals specifically with high level distortion resulting from nonlinearity of the power transistors in a power amplifier, but does not deal with broadband noise emissions introduced by the power transistors.

For these reasons, traditional feedforward cancellation arrangements are not sufficient to implement a frequency agile duplexer architecture, especially in a radio platform which can be reconfigured to operate at high power levels in multiple modes and in multiple frequency bands.

### SUMMARY OF THE INVENTION

The present invention is directed to alleviating the problems of the prior art.

The present invention overcomes the problems of the prior art by providing an electronic duplexer which is able to correct for broadband emission noise introduced by power amplifier, reduce interference caused by the transmit signal and observed in the receive path and identify and correct interference signals other than those created by the transmit signal. In particular, the invention provides an electronic duplexer for sharing at least one antenna between at least one transmitter in a transmit path and at least one receiver in a receive path. The electronic duplexer comprises an electronic duplexer input for receiving at least one input transmit signal from the transmit path and an electronic duplexer output for providing at least one desired output signal to the receive path. An antenna interface has a transmit portion for transmitting an at least one desired transmit signal over the at least one antenna and a receive portion for receiving an at least one receive signal over the at least one antenna. A transmit antenna emissions correction circuit has an input coupled to the antenna interface. The transmit antenna emissions correction circuit correcting broadband noise emissions from the transmit path in the at least one input transmit signal thereby providing an at least one corrected transmit signal. A transmit interference correction circuit has an input coupled to the transmit portion of the antenna interface and an output coupled to the receive portion of the antenna interface. The transmit interference correction circuit correcting interference of the at least one transmit signal in the receive path thereby providing a first at least one corrected receive signal. An arbitrary interferer correction circuit has an input coupled to the receive portion of the antenna interface and an output coupled to the electronic duplexer output. The arbitrary interferer correction circuit correcting interference of signals other than the broadband noise emissions from the transmit path and the interference of the at least one transmit signal in the receive path thereby providing the at least one output receive signal.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

FIG. 1 is a schematic diagram illustrating according to a first embodiment of the present invention;

FIG. 2 is a schematic diagram according to a second embodiment of the present invention;

FIG. 3 is a schematic diagram according to a third embodiment of the present invention;

FIG. 4 is a schematic diagram according to a fourth embodiment of the present invention;

FIG. 5 is schematic diagram according to a fifth embodiment of the present invention; and

FIG. 6 is a schematic diagram according to a sixth embodiment of the present invention.

### DETAILED DESCRIPTION OF THE EMBODIMENTS

In order to lighten the following description, the following acronyms will be used:
AIC Arbitrary Interferer Correction
BTS Base Station
FF Feed Forward
FFCL Feed Forward Cancellation Loop
LNA Low Noise Amplifier
MIMO Multiple Input, Multiple Output
PA Power Amplifier
RF Radio Frequency
TAEC Transmit Antenna Emissions Correction
TIC Transmit Interference Correction

As indicated above, the present invention addresses the issues brought out by the aforementioned prior art.

A preferred embodiments presented is shown in FIG. 1. An electronic duplexer 110 is disposed between the output of the radio's PA 111 at the transmit end 112 of the BTS front end 113, the antenna feed or the transmit/receive path 114 and the input 115 of LNA 116 at the receive end 117. In this embodiment, the transmit/receive path 114 share the use of antenna 118.

The electronic duplexer 110 is comprised of a first FFCL 120 disposed at the output of the PA 111. The FFCL 120 is used to correct broadband noise emissions, that is, those that do not include linearity close-in emissions, from the PA 111. A second FFCL 121 is used at the antenna coupler 122 to reduce the interference of the transmit signal in the receive path 114 of the antenna 118. A third FFCL 123 is used at the input of the LNA 116 to identify interference signals other than those identified at the transmit end 112 and to correct those additional interfering signals.

A first filter circuit 124 is placed between the first FFCL 120 and the second FFCL 121. A second filter circuit 125 is placed between the second FFCL 121 and the third FFCL 123. The second FFCL 121 includes transmit interference correction block 132 which operates as a filter to remove signal interference or unwanted noise. Such a filter is described in U.S. Pat. No. 7,702,295. The third FFCL 123 includes an arbitrary interferer correction filter circuit 133. Such a filter is described in detail in published international patent application WO 2010/063097.

It will be understood by those knowledgeable in the art that the position of the main path filters 124 and 125 may be chosen advantageously within the transmit and receive paths around the correction combining points depending on the most suitable choices for noise budget, power, gain and linearity of signal processing components.

In a reduced order system, the main path filters are designed for a conventional passband (typically covering one operating band or sub-band). The lack of rejection from the main path filters resulting from the reduced order is recovered through the correction from the electronic correction circuits. In a frequency agile system, the main path filters are designed to whatever order is required for a passband that covers all of the necessary operating frequencies. Where the passband filters cover multiple operating bands, then the FFCL provide the signal attenuation required to meet operational requirements.

With reference to the first FFCL 120, the output of PA 111 is coupled into a transmit antenna emission correction block 130. The emissions correction block 130 manipulates the coupled signal to eliminate the modulated transmit signal so as to capture substantially all of the broadband noise emissions of the PA 111. In particular, the broadband noise emissions are then phase shifted 134, amplitude scaled 135, and a buffer 136 such that when added back 131 into the main path, the broadband noise emissions are substantially eliminated from the PA output signal.

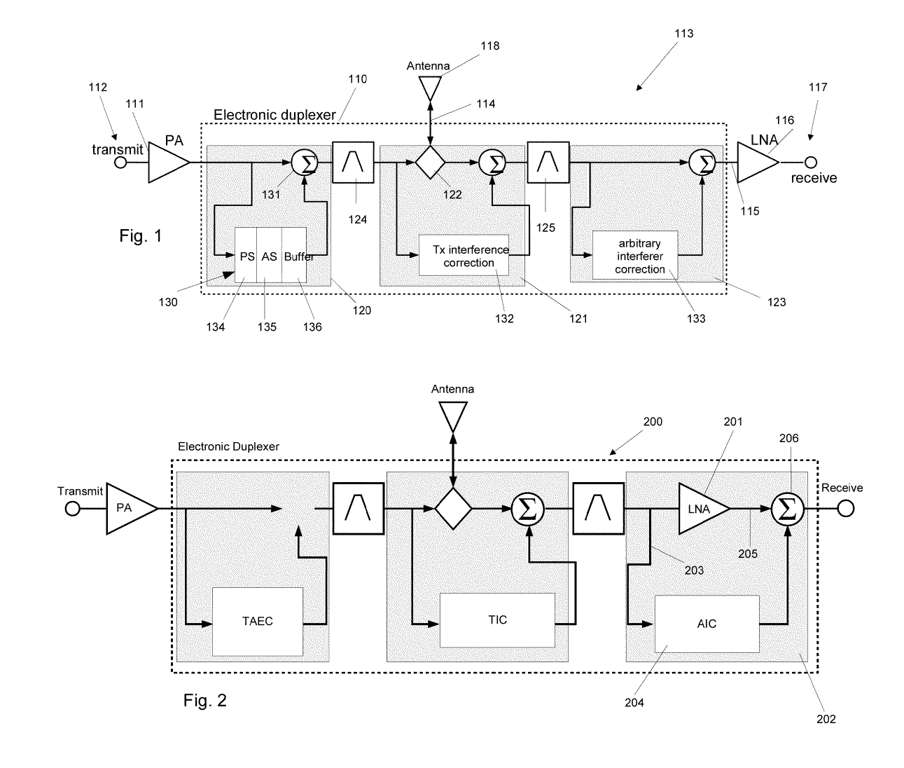

Referring now to FIG. 2, there is shown a block diagram of an electronic duplexer circuit 200 according to a second embodiment of the invention. In this embodiment, the low noise amplifier 201 forms part of the electronic duplexer circuit 200 and is located inside the arbitrary interferer correction loop 202, that is, between the input 203 of the arbitrary interferer correction block 204 and input 205 adder 206. The placement of the LNA 201 inside the correction loop 202 can improve the provision of gain, linearity, noise or power levels of the circuit. The LNA 201 can be included in one or more correction loops so as to improve noise, power and linearity budgets within the correction loops.

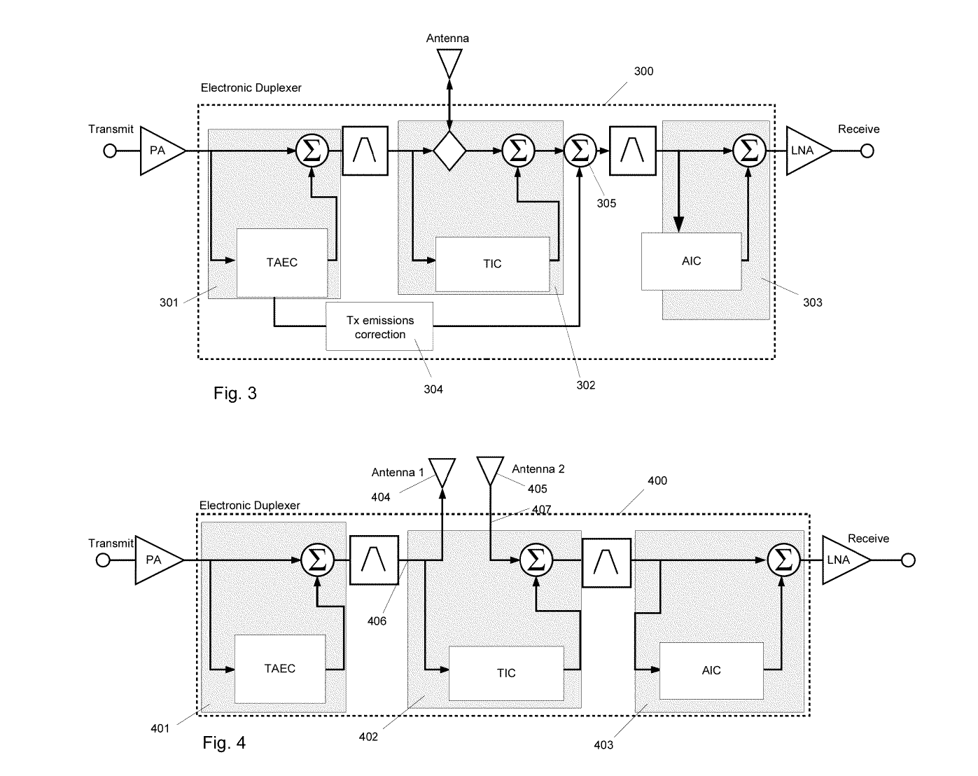

Referring now to FIG. 3, there is shown a block diagram of an electronic duplexer circuit 300 in accordance with a third embodiment of the invention. In this embodiment, electronic duplexer circuit 300 is also provided with a first FFCL 301 used to correct broadband noise emissions, a second FFCL 302 is used to reduce the interference of the transmit and a third FFCL 303 used to correct those additional interfering signals. However, the FFCL 301 is provided with a second stage emissions correction block 304. This second stage becomes useful when transmission emissions of a radio system at the antenna are higher than at the receiver. The first stage correction 301 ensures that the antenna transmit emissions requirements are met, whereas the second stage of correction 304 ensures that the transmitted emissions at the input of the receiver are met. In this embodiment, the output of the correction block 304 is sent to an adder 305 located at the output of FFCL 302. It should be noted that if the emissions correction for the antenna is substantially lower than the correction before the receiver, then a separate second stage of emissions correction may be included for the receive side correction.

Those skilled in the art will understand that the location at which the output of second stage correction block 304 is added into the receive path may change depending on the noise, gain, power, linearity and interactions with other correction loops.

With reference to FIG. 4, we have shown a block diagram of an electronic duplexer circuit 400 in accordance with a fourth embodiment of the invention. Electronic duplexer circuit 400 is also provided with a first FFCL 401 used to correct broadband noise emissions, a second FFCL 402 is used to reduce the interference of the transmit and a third FFCL 403 used to correct those additional interfering signals. However, in this embodiment, the radio system is provided with antenna diversity by means of first antenna 404 and a second antenna 405. Antenna diversity allows for separate antennae for transmit and receive paths. In order to permit the correction of transmission interference, the transmit interference correction FFCL 402 is connected between the transmit path 406 of the first antenna 404 and the receive path 407 of antenna 405 so as to cancel any transmit signal that couples directly onto the receive antenna 405.

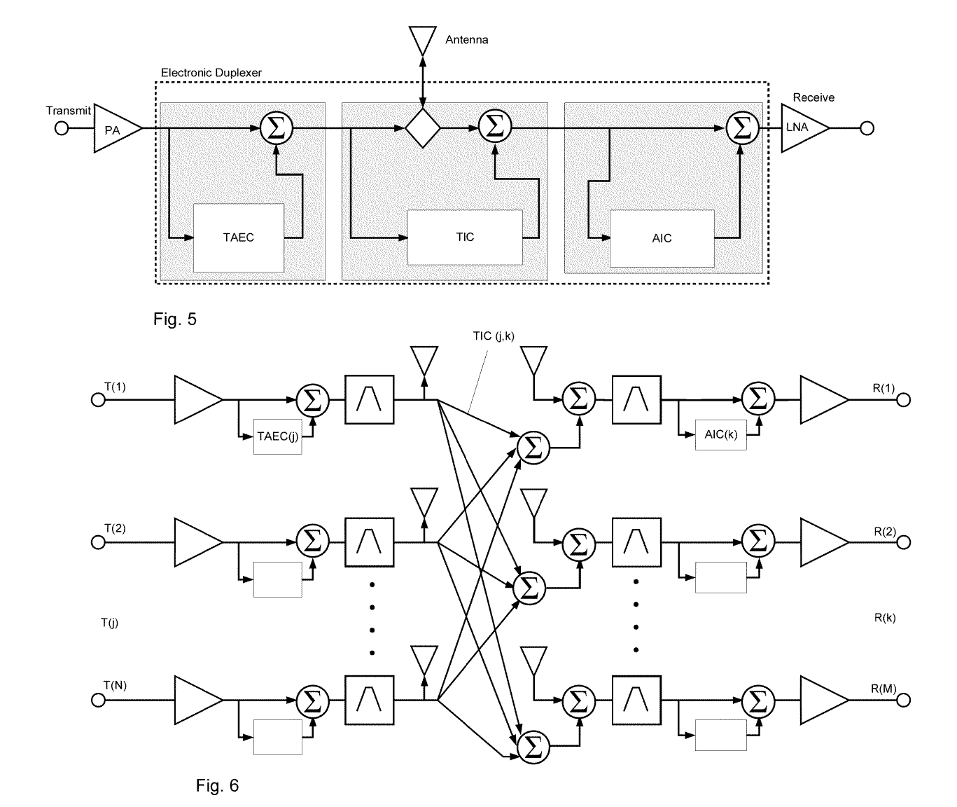

FIG. 5 shows a block diagram of an electronic duplexer according to a fifth embodiment of the invention. This embodiment is similar to the first embodiment of FIG. 1, however, in FIG. 5, the main path filters have been removed such that the radio system relies on the correction abilities of the FFCLs to provide all the signal rejection required to meet the radio system operational requirements. The lack of filters in the main path provides the potential for maximum frequency agility.

FIG. 6 shows a block diagram of a sixth embodiment of the invention. This embodiment illustrates the use of FFCLs in a general N×M MIMO system with multiple (N) transmitters and multiple (M) receivers.

Each TX branch has its own TAEC and each RX branch has it's own AIC. In the most general case of N×M MIMO (N TX, M RX) then a TIC is needed for each TX to every RX.

I claim:

1. An electronic duplexer for sharing at least one antenna between at least one transmitter in a transmit path and at least one receiver in a receive path, the electronic duplexer comprising:
a) an electronic duplexer input for receiving at least one input transmit signal from the transmit path;
b) an electronic duplexer output for providing at least one desired output signal to the receive path;
c) an antenna interface having a transmit portion for transmitting an at least one desired transmit signal over the at least one antenna and a receive portion for receiving an at least one receive signal over the at least one antenna;
d) a transmit antenna emissions correction circuit having an input coupled to said antenna interface, said transmit antenna emissions correction circuit correcting broadband noise emissions from the transmit path in the at least one input transmit signal thereby providing an at least one corrected transmit signal;
e) a transmit interference correction circuit having an input coupled to said transmit portion of the antenna interface and an output coupled to the receive portion of said antenna interface, said transmit interference correction circuit correcting interference of the at least one transmit signal in the receive path thereby providing a first at least one corrected receive signal; and
f) an arbitrary interferer correction circuit having an input coupled to the receive portion of said antenna interface and an output coupled to said electronic duplexer output, said arbitrary interferer correction circuit correcting interference of signals other than the broadband noise emissions from the transmit path and the interference of the at least one transmit signal in the receive path thereby providing the at least one output receive signal.

2. An electronic duplexer as defined in claim 1, wherein said transmit antenna emissions correction circuit comprises:
i) a phase shifter for phase shifting an incoming transmit antenna emission signal to produce a phase shifted transmit antenna emissions signal;
ii) an amplitude scaler connected to said phase shifter for amplifying said phase shifted transmit antenna emissions signal; and
iii) a delay buffer to adjust the delay of said phase shifted transmit antenna emissions signal such that, when added back into the transmit path, broadband noise emissions are substantially eliminated.

3. An electronic duplexer as defined in claim 1, wherein a low noise amplifier is connected in parallel with said arbitrary interferer correction circuit to further improve gain and linearity levels of said arbitrary interferer correction circuit.

4. An electronic duplexer as defined in claim 1, further comprising a transmit emissions correction circuit connected between said transmit antenna emissions circuit and the output of said transmit interference correction circuit.

5. An electronic duplexer as defined in claim 1, wherein said one desired transmit signal of said antenna interface is transmitting over a first antenna and said at least one receive signal is received at a second antenna.

6. An electronic duplexer as defined in claim 1, wherein said at least one transmitter is at a transmit branch N and said at least one receiver is at a receive branch M of an N×M MIMO system.

7. A method of reducing broadband emission noises at an electronic duplexer, said duplexer having at least one antenna between at least one transmitter in a transmit path and at least one receiver in a receive path, said method comprising:
a) receiving at least one input transmit signal from the transmit path;
b) providing at least one desired output signal to the receive path;
c) transmitting an at least one desired transmit signal over the at least one antenna and a receive portion for receiving an at least one receive signal over the at least one antenna;
d) correcting broadband noise emissions from the transmit path in the at least one input transmit signal thereby providing an at least one corrected transmit signal;
e) correcting interference of the at least one transmit signal in the receive path thereby providing a first at least one corrected receive signal; and
g) correcting interference of signals other than the broadband noise emissions from the transmit path and the interference of the at least one transmit signal in the receive path thereby providing the at least one desired output receive signal.

8. A method as defined in claim 7, wherein said step of correcting broadband noise emissions further comprises:
i) phase shifting an incoming transmit antenna emission signal to produce a phase shifted transmit antenna emissions signal;
ii) amplitude scaling said phase shifted transmit antenna emissions signal; and
iii) adjusting the delay of said phase shifted transmit antenna emissions signal such that, when added back into the transmit path, broadband noise emissions are substantially eliminated.

9. A method as defined in claim 7, further comprising connecting a low noise amplifier in parallel with said arbitrary interferer correction circuit to further improve gain and linearity levels of said arbitrary interferer correction circuit.

10. A method as defined in claim 7, further comprising transmitting one desired transmit signal of said antenna interface over a first antenna and receiving said at least one receive signal at a second antenna.
